(19) United States
(12) Patent Application Publication
(10) Pub. No.: US 2026/0294744 A1
(43) Pub. Date: Oct. 1, 2026

(54) System for Providing a Newborn with Batches of Breast Milk and a Method Thereto

(71) Applicant: MEDELA AG, Baar (CH)

(72) Inventors: Natalie Stevens, Baar (CH); Daniel McGowan, Wauconda, IL (US); Daniel Jason Wright, Carpentersville, IL (US); James Keclik, McHenry, IL (US)

(21) Appl. No.: 19/095,276

(22) Filed: Mar. 31, 2025

(51) Int. Cl. A61J 9/00; A61J 9/06

(52) U.S. Cl. CPC A61J 9/006; A61J 9/0653; A61J 2200/44; A61J 2200/74

(57) ABSTRACT

System for providing a newborn with breast milk, including a container to receive breast milk and fluidly connected to a tubing system to convey breast milk to the newborn, a dispensing device to convey the breast milk from the container through the tubing system to the newborn. The container can receive multiple batches of breast milk, and the dispensing device can provide at least one of the batches of breast milk from the container to the newborn. A method for providing breast milk to a newborn, wherein a container that is fluidly connected to a tubing system receives breast milk, and the tubing system conveys breast milk from the container to the newborn through a dispensing device. The container receives at least two batches of breast milk, breast milk from the container is conveyed to the newborn in a batch manner, and breast milk remains in the container between batches.

### FIELD OF THE INVENTION

The present disclosure relates to a system for providing a newborn with breast milk and a corresponding method thereto.

### BACKGROUND

Premature infants, i.e. those born before a gestational age of 37 weeks, multiple-birth infants, such as twins or triplet, and other newborns facing early health challenges, typically spend the initial phase of their lives in a neonatal intensive care unit, or “NICU”. Here, these newborns are able to gain strength and grow, while being provided with continuous care and monitoring by specifically trained medical staff. However, in most neonatal intensive care units, the newborn is separated from the mother, especially since most mothers are discharged from the corresponding hospital well before their newborn. This presented a practical challenge in providing the breast milk produced by the mother to the newborn. The breast milk must not only be expressed from the mother’s breast, but collected, stored, transported, and conveyed to the newborn, all while maintaining the nutritional and safety integrity of said breast milk.

While separated from their newborn, the mother typically expresses and collects the produced breast milk in specific collection receptacles provided with identifying indicia, such as the identity of the mother, the identity of the newborn for whom the breast milk is intended, the volume of breast milk collected, and the time and date of collection, for example. The collected breast milk is subsequently cooled to typical refrigerator temperatures or frozen. After gathering a certain amount of collection receptacles containing breast milk, these are then brought to the hospital or medical clinic for feeding to the newborn. Dependent on the age and medical condition of the newborn, provision of breast milk from the mother to the hospital may occur multiple times a day, daily, every few days, or even weekly. Once received by the medical personnel, the breast milk is then typically stored in a cooled storage facility of the NICU, until required by the newborn.

The general feeding schedule of a newborn requires the conveyance of breast milk to the newborn approximately every three hours. Consequently, the responsible healthcare professional collects the breast milk to be fed to the newborn, confirming that the breast milk corresponds to said newborn and the other identifying indicia are correct. Thereafter, they may prepare a fortified mixture with the breast milk to increase at least one or more of the fat, protein, and carbohydrate contents thereof, prior to transferring the breast milk to a dispensing system operatively and fluidly connected to an enteral feeding pump, for providing the newborn with the breast milk. An enteral feeding pumping is generally required, as the newborn has not yet developed the ability to feed orally, due to the complex suck-swallow-breathe mechanism it has not yet developed. The enteral feeding pump is then manually programmed by the healthcare professional to personalize the required feeding program for the specific newborn being fed. Such a feeding program is typically prescribed and ordered by the attending physician. Once the breast milk has been conveyed to the newborn, the health care professional disengages the newborn from the enteral feeding pump and prepares the enteral feeding pump for use for a different newborn.

Since the enteral feeding pump is only connected to the newborn during feeding of the breast milk to the newborn, a process that typically corresponds to approximately 15-20 minutes, the enteral feeding pump may be made available to more newborn in the NICU, generally reducing the required equipment of the NICU. Nonetheless, as each newborn requires the enteral feeding pump e.g. every three to four hours, the healthcare professional’s time is predominantly occupied with not only preparing the breast milk but also assembling and manually programing the enteral feeding pump for each newborn patient. Moreover, after every use, the health care professional must disassemble and disinfect the enteral feeding pump so that a different newborn patient may be connected thereto.

Consequently, the present invention aims to provide a system for providing a newborn with breast milk, in addition to a corresponding method thereto, that may reduce the amount of required human interaction therewith during feeding of said newborn.

According to a first aspect of the present invention, there is provided a system for providing a newborn with breast milk, comprising a container adapted to receive said breast milk and fluidly connected to a tubing system to convey the breast milk to the newborn and a dispensing device adapted to convey the breast milk from the container through the tubing system to the newborn. The container is adapted to receive multiple batches of breast milk and the dispensing device is further adapted to provide at least one of the batches of breast milk from the container to the newborn.

The tubing system conveys the breast milk from the container to the newborn and may physically define the flow path of the breast milk from the container to the newborn. The tubing system may include at least one flexible tube that may be constructed of polyvinyl chloride (PVC), polyurethane, or silicone. The tubing system may be directly coupled with the container. The tubing system may further comprise a nasogastric or orogastric tubing section to be introduced to the newborn’s respective anatomy.

The container may be a rigid article, such as commonly associated with a breast milk bottle or syringe dispenser, or a flexible component, such as a breast milk bag or pouch. Preferably, the container is either a breast milk bag or a syringe dispenser. With respect to the latter, a syringe dispenser may include a plunger that tightly fits into a cylindrical barrel of the syringe dispenser; however, a syringe dispenser does not necessarily require a plunger.

The container is adapted to receive multiple batches of breast milk. Preferably, the container may be adapted to receive at least two, preferably three, more preferably at least four, batches of breast milk.

A batch of breast milk may be considered the amount of breast milk associated with a single, individual feeding session of a newborn. That is, a batch of breast milk may be the amount of breast milk a newborn consumes in one sitting.

The amount of breast milk a newborn drinks during a single feeding session is dependent on various factors, including but not limited to the age of the newborn, the health status of the newborn, as well as the birthing conditions of said newborn. Newborns are generally provided breast milk every two or three to five or six hours, preferably every four hours.

By implementing a system that includes a container with multiple batches of breast milk, a newborn could remain engaged with said system for a longer duration, without the need for intensive medical staff intervention. The system may automatically provide a single batch of breast milk to the newborn at a selected time interval, without a healthcare professional preparing the breast milk or assembling the system between such batches.

Preferably, the container may receive and accommodate multiple batches of breast milk concurrently, i.e. at the same time. The container may receive multiple batches of breast milk during use thereof. Furthermore, the container is preferably not removed, replaced or refilled between during use thereof, i.e. between at least two batched conveyances of breast milk from the container to the newborn.

The dispensing device is adapted to convey the breast from the container, through the tubing system, and to the newborn. In particular, the dispensing device may comprise a pump, to achieve such conveyance of the breast milk. The dispensing device may provide forces responsible for extracting the breast milk from the container, conveying the breast milk through the tubing system and providing said breast milk to the newborn.

Moreover, the dispensing device is also adapted to provide at least one of the batches of breast milk from the container to the newborn. In particular, the dispensing device may be adapted to repetitively convey a controlled amount of breast milk to a newborn for a specific duration followed by a period of intermission, wherein no breast milk is conveyed to the newborn. As such, the dispensing device may be adapted to retain breast milk in the container, especially between batched conveyance of the breast milk to the newborn. The dispensing device may be operatively connected to the tubing system.

The system may further comprise a control unit operatively connected to the dispensing device for controlling the operation of said dispensing device. The control unit may be operatively connected to the dispensing device by means of a wireless or wired connection.

Furthermore, the system may also comprise a user interface operatively connected to the control unit. The control unit may be operatively connected to the user interface by means of a wireless or wired connection.

The user interface may be adapted to receive input, preferably from a user, and provide said input to the control unit, in order to control the operation of the dispensing device. More specifically, input provided over the user interface may instruct the control unit to set at least one dispensing parameter of the dispensing device. Preferably, input may be provided over the user interface prior to and during operation of the system, so that the input over the user interface may not only set at least one of the dispensing parameters but may adjust at least one of the dispensing parameters during use of the system. As such, the control unit may be adapted to set and adjust at least one of the dispensing parameters of the dispensing device. Therefore, dispensing parameters may be modified and adjusted during the conveyance of breast milk from the container, through the tubing system, and to the newborn. Moreover, the user may also set the dispensing parameters prior to the operation or use of the system, i.e. prior to breast milk being conveyed from the container.

The user interface may comprise at least one or more of a touch screen, a setting dial, and a press button. Moreover, the user interface may further comprise a display, which may display at least one or more of the currently set dispending parameters, real-time information regarding the dispensing parameters, and patient information of the newborn, amongst others.

A dispensing parameter is at least one or more of a dispensing time of a batch, a breast milk amount of a batch, and an interval time between two subsequent batches.

The dispensing time of a batch may be defined as the duration during which breast milk is being conveyed from the container to the newborn, i.e. a period during which the newborn receives the breast milk. A dispensing time may be between 1 and 60 minutes, preferably between 10 and 50 minutes, more preferably between 20 and 40 minutes and more preferably 30 minutes .

A breast milk amount of a batch may be defined as the amount of milk provided to the newborn during a batch, which may be associated with a single feeding session. Although preferably given as a volumetric unit of measure, the breast milk amount of a batch may also be provided as a mass value.

An interval time between two subsequent batches may be defined as the period wherein no breast milk is conveyed to the newborn. As such, an interval time between two subsequent batches may refer to an intermission time between singular feeding sessions, each associated with a batch of breast milk. An interval time between two subsequent batches may be between 2 and 6 hours, preferably between 3 and 5 hours, and more preferably 4 hours.

The system may further comprise a reader operatively connected to a control unit and adapted to identify an identifier, wherein the identifier instructs the control unit to set at least one dispending parameter of the dispensing device. The identifier may be associated with the container and may be preferably located on or in said container. Furthermore, the identifier may be a computer chip or other non-transitory data storage media, such as an NFC tag or an RFID tag, or written in a machine-readable format, such as a QR-code or bar code. The identifier may be used to confirm that the dispensing parameters set via the user interface correspond to those associated with the breast milk received in the container.

In a further development of the invention, the system may comprise a housing adapted to support the container. In order to do so, the housing may comprise at least one support on an outer surface of the housing to support the container. Such a support may comprise at least one or more of a bracket, a hook, a peg, and similar mounting system components.

In an alternative embodiment, the housing may exhibit a recess to accommodate the container. The recess may be formed to reflect the general shape of the container, especially the outer boundary contour of the said container, preferably when filled with breast milk. Moreover, the recess may include at least one support, on which the container may be placed or hung, for example. Such a support may carry the weight of the container. Preferably, a support may be realized by a hook, an arm, or a peg, for example.

The housing may further include a cover associated with the recess so that the recess and the cover forms a boundary of a closed compartment adapted to accommodate the container. This may represent a closed position of the cover and the recess. Together, the recess and cover establish an outer boundary such that the container may be fully encompassed by the housing within said closed compartment. Preferably, the shape of the closed compartment reflects the general contour of the container, in particular the general contour of the container with breast milk, preferably filled with breast milk.

The cover, which may be a separate component from the housing, may be attached thereto via a latching system or a hinge or sliding construction. The latter may allow the user to open the closed compartment with one hand, thereby enabling ease of use.

Preferably, when in a closed position, the cover and the recess establish a sealed closed compartment. This may establish a sealed atmospheric environment in the closed compartment.

Preferably, the cover may include window or be constructed of a transparent material, such as polycarbonate, Poly(methyl methacrylate) (PMMA), or polyethylene terephthalate (PET). Such a construction allows for a quick visual verification of the fill-status of the container, in addition to other information provided on said container, without the need to open the closed compartment or handle the container during use thereof.

Furthermore, the cover of the housing may include at least one aperture through which the tubing system may pass. Preferably, such an aperture includes a sealing component, such as a sealing ring, in order to ensure that the closed compartment remains sealed against the outside environment of the housing.

The housing according to any embodiment of the invention may contain the dispensing device.

The housing may further include a carrying handle to improve the transportability of the system.

Moreover, at least one or more of a user interface and a reader may be located on the housing, preferably on an outside boundary thereof.

In a further embodiment, the system may further comprise a weight-detecting means for determining the weight of the container. The weight-detecting means preferably includes a weight-detecting sensor associated with the container and operatively connected to the control unit. Preferably, the control unit further comprises a processor, which is adapted to receive and record the weight values measured by the weight-detecting sensor and compare them with provided control values. This may establish a feedback mechanism to allow for the control and confirmation that the amount of breast milk actually being conveyed to the newborn corresponds to the instructions provided to the control unit. The amount of breastmilk being conveyed to the newborn may be displayed in real-time on a display of a control unit.

Preferably, the weight-detecting sensor continuously measures the weight of the container. The weight-detecting sensor may at least measure the container prior to the first conveyance of breast milk, during conveyance of breast milk, between each batch of breast milk, and after conveyance of the final batch of breast milk.

Furthermore, the weight-detecting sensor is adapted to detect shock or vibrational conditions, for example those that may suggest non-ideal conveying conditions. In such a case, the values provided to the control unit may instruct the dispensing device to pause further conveyance of the breast milk until said conditions have subsided. Preferably, the detection of such conditions may be noted on the display of the user interface so that the user may be made aware of the situation and respond accordingly. Such a response may include removal of the disturbance or an override of the paused conveyance.

Preferably, the weight-detecting sensor is associated with a support supporting the container, so that a continuous measurement of the weight of the container may be achieved.

The system may further comprise an illumination component. Since systems according to the invention are typically implemented in low-light settings, the user may have difficulty reading information provided on the container, determining the fill-level of the container, selecting the correct dispensing parameters via the user interface, verifying the data provided on a display of the user interface, or assembling the system components, for example. The inclusion of an illumination component may alleviate such difficulties.

Moreover, the illumination component may be operatively connected to the user interface in such a way that input over said user interface may manually set and adjust illumination parameters of the illumination component. Such parameters may include but are not limited to an on/off setting, brightness level, color temperature, and illumination duration.

An illumination component may be located on a housing of the system, preferably directed towards the container. Specifically, an illumination component may be located in the recess of the housing so that it is contained within the closed compartment of the housing. In such a case, both the closed compartment and a therein housed container may be illuminated.

Furthermore, the illumination component may be adapted to respond to the position of a cover. Specifically, if said cover is moved from a closed position to an open position, the illumination component may automatically turn on, while the change from an open position to a closed position of the cover may cause the illumination component to turn off. The illumination component may be operatively connected to the cover.

The illumination component may further comprise a light sensor that detects ambient lighting, as well as a controller, whereby the controller may instruct the illumination component to adjust its illumination parameters based on the ambient lighting detected by the light sensor.

In a further embodiment of the invention, the system may also comprise an attachment means, in order to secure said system to a stand, such an IV pole. This enables the system to be in close proximity to the newborn while also ensuring that if the newborn requires transportation during use thereof, the system can be easily transported therewith.

Preferably, the attachment means is a two-hand activated clamp mechanism. Said clamp mechanism may be activated by the dual-depression of two activation areas, such as buttons, for example. The activation of the two activation areas may remove a clamp force from a stand, allowing for the de-installation or removal of the system therefrom. The clamp mechanism may be mechanically-based and include levers and springs, pneumatically-based and include a pressure source and pneumatic actuator, or electrically-based with a solenoid or electric actuator, for example.

Preferably, the housing of the system of any embodiment includes an attachment means.

According to a second aspect of the present invention, there is provided a method of providing breast milk to a newborn, wherein a container that is fluidly connected to a tubing system receives the breast milk and the tubing system conveys said breast milk from the container to the newborn. Moreover, the container receives at least two batches of breast milk. The breast milks is conveyed from the container to the newborn in a batch manner comprising at least two batches and breast milk remains in the container between the at least two batches.

Preferably, the container receives the at least two batches of breast milk, preferably all batches of breast milk that will be conveyed to the newborn, during a single receiving step. The at least two batches of breast milk may be provided to the container concurrently or in short succession of each other.

Once the container has received the at least two batches of breast milk, it may then be fluidly connected to the tubing system. Preferably, the container is directly connected to the tubing system. Furthermore, the tubing system is preferably connected to a dispending device, which may ensure that the breast milk is conveyed from the container, through the tubing system, and to the newborn. The tubing system may be operatively connected to the dispensing device prior to being fluidly connected to the container. Preferably, the dispensing device retains the breast milk within the container between the conveyance of the at least two batches of breast milk.

Preferably, the tubing system is fluidly connected to the newborn, prior to conveyance of the breast milk from the container. Furthermore, the tubing system preferably remains fluidly connected to the newborn between the conveyance of the at least two batches of breast milk. Specifically, the tubing system may not be replaced or removed from the newborn between the conveyance of the at least two batches of breast milk. In particular, the tubing system is disengaged from the newborn only if it has received all batches of breast milk received in the container, preferably when the container is empty.

Conveying the breast milk from the container may refer to the extraction or removal of the breast milk from said container and the subsequent flow of breast milk in the direction of the newborn via the tubing system. Therefore, conveying breast milk from the container may be considered the exiting of said breast milk from the container.

The breast milk is conveyed from the container, through the tubing system, and provided to the newborn in a batch manner. A batch manner may refer to a cyclic or repetitive amount of breast milk that is provided to a newborn within a specific time frame, wherein no breast milk is conveyed to the newborn between said subsequent batches. The time between subsequent batches wherein no milk is conveyed to the newborn may be considered an interval time. During such an interval time between subsequent batches, preferably no breast milk is conveyed from the container, conveyed through the tubing system, or provided to the newborn. In particular, the remaining batches of breast milk remain in the container between the conveyance of the subsequent batches.

Preferably, the container remains fluidly connected to the tubing system between the conveyance of the at least two batches of breast milk. Specifically, the container may not be replaced or removed from the tubing system between the conveyance of the at least two batches of breast milk. Moreover, the container may not receive further or additional batches of breast milk between the conveyance of the at least two batches of breast milk.

Once the at least two batches of breast milk, preferably all batches of breast milk received in the container, have been conveyed from the container and provided to the newborn, the container may be disconnected from the system, in particular the tubing system. Preferably, the container is empty when being disconnected from the system. More specifically, the container may be empty after providing the newborn with the at least two batches of breast milk.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth. As used herein "(s)" following a noun could mean the plural and/or singular forms of the noun.

Further details, advantages or features of the present invention will become apparent from the following description in combination with the figures. Examples of embodiments of the invention will be further described with reference to the figures, in which,

### BRIEF DESCRIPTION OF THE SEVERAL VIEWS OF THE DRAWINGS

FIG. 1 illustrates a perspective view of a first embodiment of a system;

FIG. 2 illustrates an additional perspective view of a first embodiment of a system;

FIG. 3 illustrates a perspective view of a second embodiment of a system:

FIG. 4 illustrates a side-view of a container on a support;

FIG. 5 illustrates a perspective view of an embodiment of a system with a cooling system and an agitation system;

FIG. 6 illustrates a side-view of a container accommodated within a housing and connected to a re-circulation arrangement of an agitation system;

FIG. 7a illustrates a side-view of a container and a vibration means of a container agitation means accommodated within a housing;

FIG. 7b illustrates a side-view of a container and a vibration means of a container agitation means accommodated within a housing;

FIG. 8a illustrates a side-view of a container and a reciprocating piston of a container agitation means accommodated within a housing;

FIG. 8b illustrates a side-view of a container and two reciprocating pistons of a container agitation means accommodated within a housing;

FIG. 9a illustrates a side-view of a container and a rotating cam of a container agitation means accommodated within a housing; and

FIG. 9b illustrates a side-view of a container and two rotating cams of a container agitation means accommodated within a housing.

### DETAILED DESCRIPTION OF THE PREFERRED EMBODIMENTS

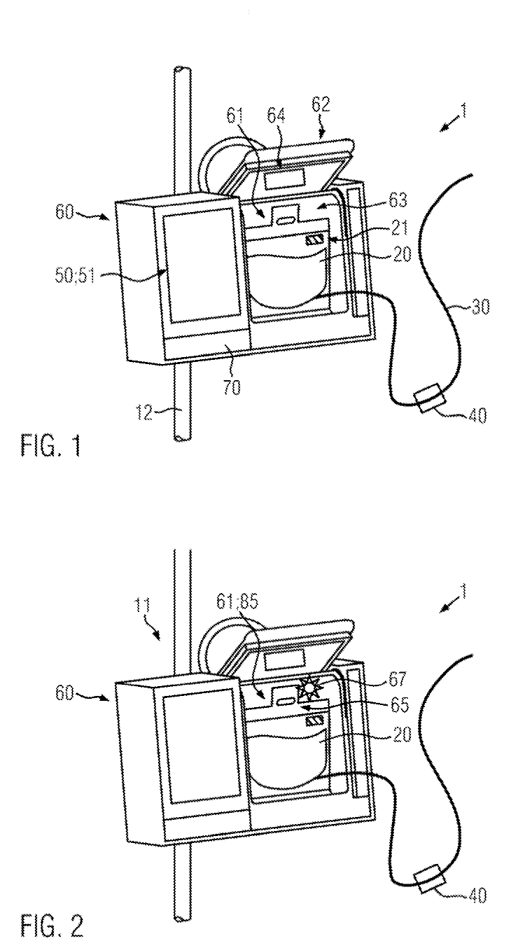

A first embodiment of a system 1, as illustrated in FIGS. 1 and 2, manifests a container 20 fluidly connected to a tubing system 30 and a dispensing device 40 adapted to convey breast milk from the container 20 through the tubing system 30 to a newborn; e.g. the dispensing device is a pump such as a volumetric pump. A warmer (not shown) may be provided on the tubing system 30, to warm the breast milk to a temperature adapted for feeding the breast milk to the newborn. The container 20, which is depicted as a breast milk bag, is adapted to receive multiple batches of breast milk, while the dispensing device 40 is adapted to provide at least one of said batches of breast milk from said container 20 to the newborn.

The container 20 is supported by support 65 located within a recess 61 of housing 60, wherein said recess 61 is closed by a cover 62 with a window 64. Together, the recess 61 and the cover 62 form a boundary of a closed compartment 63, which surrounds and accommodates the container 20. The window 64 of the cover 62 enables a user to optically review and identify the amount of breast milk within the container 20 without the necessity of opening the cover 62 to the closed compartment 63, in order to do so. Moreover, the cover 62 exhibits an aperture through which the tubing system 30, which is directly connected to the container 20, may pass, allowing for said cover 62 to remain closed during use of the system 1.

The housing 60 of the system 1 further comprises a user interface 51 constructed as a touch screen with a display and operatively connected to a control unit 50, which in turn is operatively connected to the dispensing device 40 for controlling the operation thereof. The user interface 51 allows the provision of input, in order to set and adjust at least one dispensing parameter, such as dispensing time of a batch of breast milk, a breast milk amount of a batch, and an interval time between two subsequent batches, of the dispensing device 40. Moreover, the display of the user interface 51 displays the currently implemented dispensing parameters, as well as further settings, including the conditions of the closed compartment 63 and user data, for example.

Moreover, the system 1 also includes a reader 70 positioned on the housing 60, wherein said reader 70 is adapted to identify an identifier 21 located on the container 20. The identifier 21, which may be realized as a QR-code, NFC tag, or RFID tag, provides the reader 70 with information regarding the breast milk associated with the container 20, in addition to pre-defined dispensing parameters. Since the reader 70 is operatively connected to the control unit 50, the data provided by the identifier 21 to the reader 70 can directly instruct the control unit 50 without the need to input said parameters via the user interface 51.

The housing 60 of the first embodiment not only exhibits a carrying handle 11 to enable simplified transportation and re-location thereof, but also an attachment means to secure the housing 60 to a stand 12, such as an IV pole. The attachment means is a two-handed clamp mechanism activated by the dual-depression of two buttons, which removes the clamp force from the stand 12 so that the housing 60 may be installed or removed therefrom.

As illustrated in FIG. 2, the recess 61 of the housing 60 includes an illumination component 67 that provides light to the closed compartment 63. The illumination component 67 is operatively connected to the user interface 51 and control unit 50, so that the illumination of the closed compartment 63 or the recess 61 can be manually set and adjusted via user input over the user interface 51. Additionally, the illumination component 67 is also operatively connected to the cover 62 in such a way that positioning the cover 62 into an open position, such as that depicted in FIG. 2, results in the illumination of the recess 61 and the container 20 accommodated therein.

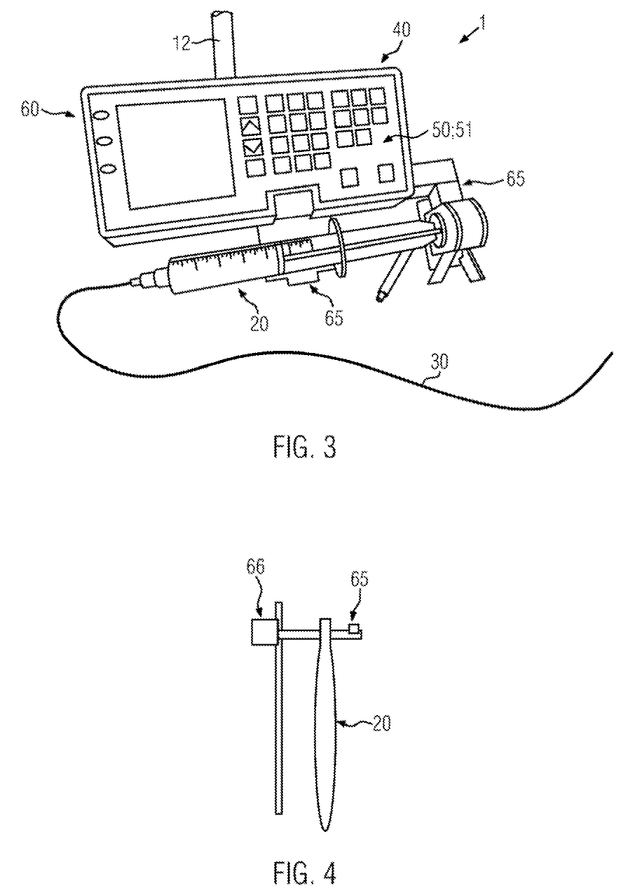

FIG. 3 illustrates a second embodiment of the system 1, wherein the supports 65 of the housing 60 that support and accommodate the container 20 project from a bottom side of said housing 60. In said embodiment, the container 20 is realized by a syringe dispenser, which is fluidly connected to the tubing system 30.

As depicted in the embodiment according to FIGS. 1 and 2, as well as the embodiment of FIG. 3, at least two preferably at least four batch amounts of breast milk are provided to and received in the container 20. Subsequently, the container 20 is fluidly connected to the tubing system 30, which is operatively connected to the dispensing device 40, and placed on the supports 65 of the housing 60. Thereafter, the tubing system 30 is fluidly connected to the newborn.

The user than provides input over the user interface 51 regarding the dispensing time of the breast milk batches, a breast milk amount of each batch, and an interval time between two subsequent batches. Subsequently, the control unit 50 instructs the dispensing device 40 accordingly and the breast milk is conveyed from the container 20, through the tubing system 30, and to the newborn in a batch manner. The container 20 remains connected to the tubing system 30 during the conveyance of all of the at least two, preferably at least four, more preferably all, batches of breast milk received in the container 20. Moreover, the container 20 is not refilled during the conveyance of said batches of breast milk or between subsequent batches. The dispensing device 40 retains the remaining batches of breast milk in the container 20 during the interval time of the batched conveyance, so that no breast milk is conveyed from the container 20 or through the tubing system 30 between batched conveyance, i.e. during the interval time between subsequent batches. A valve (not shown) may optionally be provided on the tubing system 30 to retain the remaining batches of breast milk in the container 20 during the interval time of the batched conveyance; e.g. the valve may be provided at the outlet of the container 20 or at the entrance of the dispensing device 40 or at an intermediate position between the two.

Once all batch amounts of breast milk received in the container 20 have been conveyed and provided to the newborn, that is, once the container 20 is empty, then the tubing system 30 is disengaged from the newborn.

The system 1 as illustrated in FIG. 4 further comprises a weight-detecting means, wherein the support 65 which upholds the container 20 includes a weight-detecting sensor 66. Although the side-view of the system 1 in FIG. 4 depicts the first embodiment according to FIGS. 1 and 2, it is understood that the second embodiment as illustrated in FIG. 3 may also exhibit a weight-detecting means, wherein at least one of the supports 65 is associated with a weight-detecting sensor 66.

The weight-detecting sensor 66, which is operatively connected to the control unit 50 and the user interface 51, continuously measures and records the weight of the container 20. A feedback mechanism in the control unit 50 compares the measured weight value with that of a control value to ensure that the amount of breast milk actually being conveyed by the dispensing device 40 corresponds to the value provided and instructed to the control unit 50. Furthermore, due to the sensitivity of the weight-detecting sensor 66, the system 1 is adapted to detect shock or vibration situations suggesting non-ideal conveying conditions. In such a case, the feedback mechanism of the control unit 50 would instruct the dispensing device 40 to pause further conveyance of the breast milk to the newborn and display and corresponding error message on the display of the user interface 51, so that a user may respond accordingly.

Further embodiments of the system 1 may exhibit a cooling system 80 with a cooling device 81 adapted to cool the breast milk within the container 20 to temperatures between 0 and 15 °C, preferably between 1 and 10 °C, and more preferably between 2 and 5 °C; e.g. the breast milk is cooled at a temperature of 4 °C. The cooling device 81 in such embodiments may be a heat pump, preferably a thermoelectric heat pump.

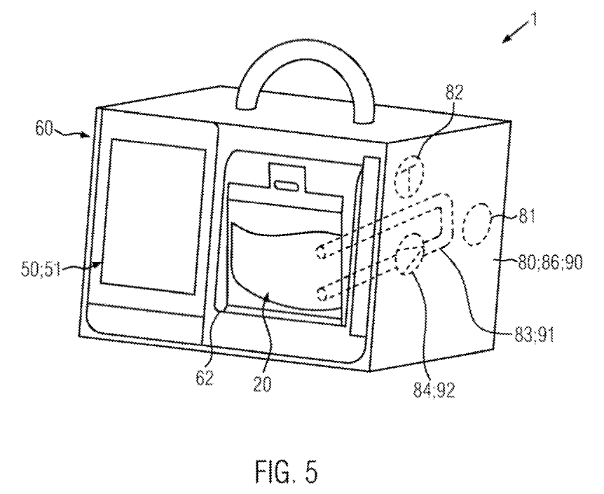

In a third embodiment of the system 1 shown in FIG. 5, the cooling system 80 comprises a breast milk cooling means 86 including a cooling line 83 fluidly connected to the container 20, a pumping device 84 for circulating the breast milk from the container 20 through the cooling line 83 to the cooling device 81 and back to the container 20. The cooling device 81 in said embodiment is a thermoelectric heat pump. The individual components of said cooling system 80 are received in the housing 60 of the system 1.

The breast milk is extracted from the container 20 via the pumping device 84 and transported through the cooling line 83 to the cooling device 81, to cool the breast milk. Since the cooling line 83 is realized as a re-circulation loop, the breast milk continues to be transported from the cooling device 81 back to the container 20 via the same pumping device 84.

In a further embodiment of a system 1 including a cooling system 80, as exemplified in FIG. 2, said cooling system 80 comprises a compartment cooling means 85 adapted to cool the closed compartment 63 of the housing 60. The closed compartment 63 is preferably thermally insulated. Moreover, by cooling the closed compartment 63, any container 20 with or without breast milk received in said closed compartment 63 would be cooled.

With respect to any embodiment of the invention including the cooling system 80, said cooling system 80 is operatively connected to the control unit 50 so that input over the user interface 51 can instruct the control unit 50 to set at least one cooling parameter of the cooling system 80, such as a cooling temperature and cooling duration. Moreover, in case of an embodiment with a breast milk cooling means 86, input over the user interface 51 can also instruct the control unit 50 to set at least one pumping parameter of the pumping device 84, such as breast milk flow rate and pumping duration. Input provided over the user interface 51 an also be implemented to adjust said parameters during cooling of the breast milk.

The temperature sensor 82 of an embodiment with a breast milk cooling means 86 may be located along the cooling line 83, preferably after the cooling device 81, or in a location associated with the container 20. In case of an embodiment with a compartment cooling means 85, the temperature sensor 82 may be located within the closed compartment 63 of the housing 60, preferably in the recess 61.

As depicted in FIG. 5, the breast milk is pumped from the container 20 via the pumping device 84 and transported along the cooling line 83 to the cooling device 81. At the cooling device 81, the breast milk is cooled to a cooling temperature, preferably as instructed by the control unit 51, and then further transported along the remaining cooling line 83 towards the container 20. The transportation of the breast milk through the breast milk cooling means 86 may occur continuously. Specifically, a portion of the breast milk may be transported through the breast milk cooling means 86 while an amount or batch of breast milk is conveyed from the container 20 through the tubing system 30 to the newborn. The breast milk may also be transported through the breast milk cooling means 86 between the conveyance of at least two batches of breast milk.

With respect to an embodiment of the cooling system 80 comprising a compartment cooling means 85, as illustrated in FIGS. 1 and 2, the closed compartment 63 is cooled when the breast milk is being conveyed from the container 20 and through the tubing system 30 and between the conveyance of at least two batches of breast milk from the container 20, i.e. when no breast milk is conveyed from the container 20.

Additional embodiments of the system 1 may also encompass an agitation system 90 to agitate the breast milk.

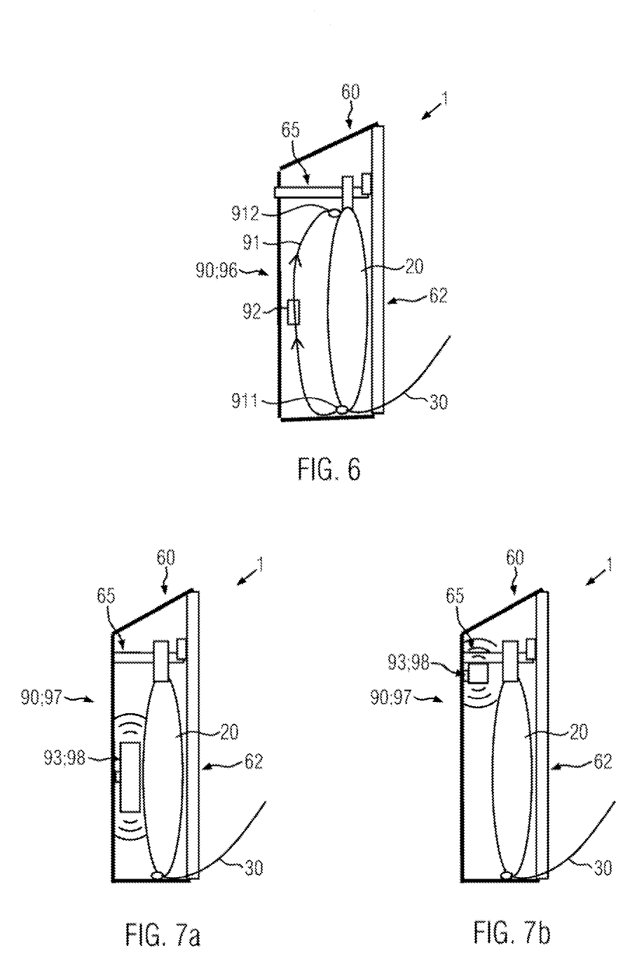

As shown in FIG. 6, such an agitation system 90 may comprise a re-circulation arrangement 96, which includes a re-circulation line 91 fluidly connected to the container 20, a pumping device 92 for circulation the breast milk from the container 20 through the re-circulation line 91 and back to the container 20. The re-circulation arrangement 96 may be received in the housing 60 of the system 1.

The re-circulation arrangement 96 provides for the circulation and consequent agitation of the breast milk in the container 20 by extracting the breast milk from the container 20 via the pumping device 92, transporting the breast milk through the re-circulation line 91, and then returning the breast milk to the container 20. Preferably, the breast milk is removed from the container 20 at an inlet 911 of the re-circulation line 91 located at the bottom of the container 20 and returned at an outlet 912 of the re-circulation line 91 associated with the top of the container 20. The re-circulation arrangement 96 also results in the flow of the breast milk within the container 20.

Moreover, the agitation system 90 may comprise a container agitating means 97 that includes an actuator 98 adapted to cooperate with the container 20, in order to agitate the breast milk within said container 20.

Such an actuator 98 may comprise a vibration means 93 adapted to provide vibrational movement to the container 20. As depicted in FIG. 7a, the vibration means 93 may be positioned in direct contact to the container 20, in order to ensure direct transmission of the vibrational forces to the breast milk within the container 20. However, the vibration means 93 may be in contact with the support 65 of the housing 60 supporting the container 20, as shown in FIG. 7b.

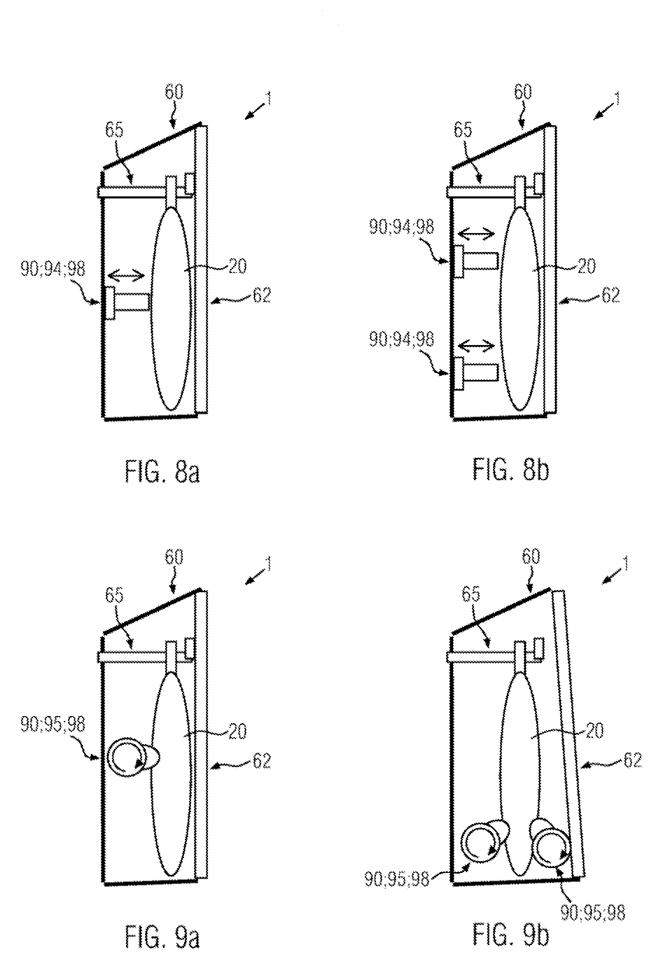

As shown in FIGS. 8a, 8b, 9a and 9b, the actuator 98 may also comprise at least one reciprocating piston 94 or at least one rotating cam 95. Preferably, the reciprocating piston 94 and the rotating cam 95 elastically deform the container 20 and locally display the breast milk within said container 20, thereby agitating the breast milk within the container 20. However, the reciprocating piston 94 and the rotating cam 95 may simply push on the container 20 without inducing elastic deformation, still ensuring movement of the container 20 and the breast milk therein.

The breast milk is agitated by the agitation system 90 prior to being conveyed from the container 20, through the tubing system 30, and to the newborn. Moreover, the agitation of the breast milk received in the container 20 may occur concurrently to breast milk being conveyed from the container 20, through the tubing system 30, and to the newborn. In particular, a portion of the breast milk may be transported through the re-circulation line 91, while an amount or batch of breast milk is conveyed from the container 20. Breast milk may also be transported through the re-circulation line 91 while no breast milk is being conveyed from the container 20; for example, between batched conveyance thereof. With respect to an embodiment with a container agitating means 97, the container 20 may be agitated, preferably elastically deformed, while an amount or batch of breast milk is conveyed from the container 20. The agitation system 90 may continuously agitate the breast milk received in the container 20.

In a further embodiment, the system 1 may comprise both an agitation system 90 and a cooling system 80, such that the agitation system 90 may encompass a re-circulation arrangement 96 or a container agitating means 97 housed within the closed compartment 63 of the housing, wherein the cooling system 80 comprises a compartment cooling means 85. Such a system 1 may be visualized in FIGS. 6 to 9b.

Alternatively, a system 1 comprising both an agitation system 90 and a cooling system 80 may exhibit a re-circulation arrangement 96 that may make use of the identical components of the breast cooling means 86. Such an embodiment is illustrated in FIG. 5. This prevents the necessity of additional components and allows for the simultaneous cooling and agitation of the breast milk.

With respect to any embodiment of the invention including an agitation system 90, said agitation system 90 is operatively connected to the control unit 50 so that input over the user interface 51 can instruct the control unit 50 to set at least one agitation parameter of the agitation system 90, such as a agitation speed and agitation duration. Moreover, in case of an embodiment with a re-circulation arrangement 96, input over the user interface 51 can also instruct the control unit 50 to set at least one pumping parameter of the pumping device 92, such as breast milk flow rate, pumping pressure, and pumping duration. Input provided over the user interface 51 an also be implemented to adjust said parameters during agitation of the breast milk.

For the purpose of the present description and of the appended claims, except where otherwise indicated, all numbers expressing amounts, quantities, percentages, and so forth, are to be understood as being modified in all instances by the term "about". Also, all ranges include the maximum and minimum points disclosed and include any intermediate ranges therein, which may or may not be specifically enumerated herein. In this context, therefore, a number A is understood as A ± 10 % of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

### LIST OF REFERENCE SIGNS

1 system

11 carrying handle

12 stand

20 container

21 identifier

30 tubing system

40 dispensing device

50 control unit

51 user interface

60 housing

61 recess

62 cover

63 closed compartment

64 window

65 support

66 weight-detecting sensor

67 illumination component

70 reader

80 cooling system

81 cooling device

82 temperature sensor

83 cooling line

84 pumping device

85 compartment cooling means

86 breast milk cooling means

90 agitation system

91 recirculation line

911 inlet

912 outlet

92 pumping device

93 vibration means

94 piston

95 cam

96 recirculation arrangement

97 container agitating means

98 actuator

What is claimed is:

1. A system for providing a newborn with breast milk, comprising
a container adapted to receive said breast milk and fluidly connected to a tubing system to convey the breast milk to the newborn,
a dispensing device adapted to convey the breast milk from the container through the tubing system to the newborn,
the container is adapted to receive multiple batches of breast milk, and
the dispensing device is further adapted to provide at least one of the batches of breast milk from the container to the newborn.

2. The system according to claim 1, the dispensing device and/or a valve is adapted to retain breast milk in the container between batches.

3. The system according to claim 1, the container is a breast milk bag.

4. The system according to claim 1, the container is adapted to receive at least two batches of breast milk.

5. The system according to claim 1, further comprising a housing adapted to support the container , wherein the housing includes a recess to accommodate the container and further comprises a cover, wherein the cover and the recess form a boundary of a closed compartment that accommodates the container .

6. The system according to claim 5, wherein the cover includes a window .

7. The system according to claim 1, further comprising a control unit operatively connected to the dispensing device for controlling the operation of said dispensing device .

8. The system according to claim 6, further comprising a user interface operatively connected to the control unit,
wherein input over the user interface instructs the control unit to set at least one dispensing parameter of the dispensing device, and
wherein a dispensing parameter is at least one of a group including a dispensing time of a batch, a breast milk amount of a batch, and an interval time between two subsequent batches.

9. The system according to claim 1, further comprising a cooling system including a cooling device adapted to cool the breast milk.

10. The system according to claim 1, further comprising an agitation system adapted to agitate the breast milk.

11. A method for providing breast milk to a newborn, comprising
receiving breast milk in a container that is fluidly connected to a tubing system,
conveying breast milk from the container to the newborn through a dispensing device via the tubing system,
receiving at least two batches of breast milk in the container,
conveying the breast milk from the container to the newborn in a batch manner, and
the breast milk remaining in the container between batches.

12. The method according to claim 11, wherein the container is not replaced or refilled between the conveyance of at least two batches of breast milk.

13. The method according to claim 11, the dispensing device and/or a valve is arranged to retain the breast milk within the container between the conveyance of the at least two batches of breast milk.

14. The method according to claim 11, and fluidly connecting the tubing system to the newborn prior to the breast milk being conveyed from the container through the tubing system in a batch manner and the tubing system remains fluidly connected to the newborn between the conveyance of at least two batches of breast milk.

15. The method according to claim 14, and fluidly disengaging the tubing system from the newborn after the at least two batches of breast milk have been conveyed from the container .

16. The method according to claim 11, and agitating the breast milk between conveying batches of breast milk.

17. The method according to claim 11, and cooling the breast milk between conveying batches of breast milk.
